(19) United States
(12) Patent Application Publication
(10) Pub. No.: US 2025/0338197 A1
(43) Pub. Date: Oct. 30, 2025

(54) CELL-SPECIFIC DYNAMIC THRESHOLDING FOR HANDOVER TRIGGERS

(71) Applicant: T-Mobile USA, Inc., Bellevue, WA (US)

(72) Inventor: Baewon SEO, Overland Park, KS (US)

(21) Appl. No.: 18/650,030

(22) Filed: Apr. 29, 2024

(51) Int. Cl. H04W 36/32; H04B 17/318; H04W 24/08; H04W 36/00

(52) U.S. Cl. CPC H04W 36/322; H04B 17/328; H04W 24/08; H04W 36/00837

(57) ABSTRACT

Solutions are disclosed that provide cell-specific dynamic thresholding for handover triggers. User equipment (UEs) collect and report received radio signal information for radio sites, such as reference signal received power (RSRP) and reference signal received quality (RSRQ) parameters, along with the UE's location and dropped call information (if calls drop). A relationship between UE distance, from the site's tower, and each of the radio signal parameters is determined, along with dropped call distances. Based on which relationship provides the superior prediction of dropped call, a handover parameter and possibly a threshold are determined specific to each cell. For example, one cell may use RSRP, an adjacent neighbor cell may use RSRQ, and another adjacent cell may use a weighted combination. This process is updated and may be repeated to continually adjust the handover criteria as cell conditions change (e.g., seasonal and other changes).

### BACKGROUND

Third Generation Partnership Project (3GPP) technical standards (TSs) identify reference signal received power (RSRP) and reference signal received quality (RSRQ) as radio signal parameters that may be used to trigger handovers of user equipment (UEs) from one cell to another cell in cellular wireless networks. Currently, wireless carriers set handover triggers on RSRP or RSRQ for an entire market (e.g., an entire geographical region, such as a metropolitan area), based on the predominant conditions in the market, with RSRQ in urban settings, and RSRP in rural settings.

### SUMMARY

The following summary is provided to illustrate examples disclosed herein, but is not meant to limit all examples to any particular configuration or sequence of operations.

Solutions are disclosed that provide cell-specific dynamic thresholding for handover triggers. Examples receive, for a first radio site of a plurality of radio sites, from each user equipment (UE) of a first plurality of UEs, received radio signal information for the first radio site, an identifier (ID) of the first radio site, and a location of the UE; using the received radio signal information, the ID of the first radio site, and the locations from the first plurality of UEs, determine a first relationship between a first radio signal parameter and UE distances from the first radio site, and a second relationship between a second radio signal parameter and UE distances from the first radio site; using the first relationship and the second relationship: select, for the first radio site, a first handover parameter comprising the first radio signal parameter but not the second radio signal parameter; or select, for the first radio site, the first handover parameter comprising the second radio signal parameter; and based on the first radio site serving a first UE, trigger a handover of the first UE using the first handover parameter.

### BRIEF DESCRIPTION OF THE DRAWINGS

The disclosed examples are described below with reference to the accompanying drawing figures listed below, wherein:

FIG. 1 illustrates an exemplary architecture that advantageously provides cell-specific dynamic thresholding for handover triggers;

FIGS. 2A and 2B illustrate a setting in which cell-specific dynamic thresholding for handover triggers, as provided by examples of the architecture of FIG. 1, may be advantageously employed;

FIG. 3 illustrates an exemplary radio signal data collection application that executes on user equipment (UEs) in examples of the architecture of FIG. 1;

FIG. 4 illustrates an exemplary dynamic thresholding logic that may be used in examples of the architecture of FIG. 1;

FIGS. 5 and 6 illustrate flowcharts of exemplary operations associated with the architecture of FIG. 1; and

FIG. 7 illustrates a block diagram of a computing device suitable for implementing various aspects of the disclosure.

Corresponding reference characters indicate corresponding parts throughout the drawings, where practical. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that provide cell-specific dynamic thresholding for handover triggers. User equipment (UEs) collect and report received radio signal information for radio sites, such as reference signal received power (RSRP) and reference signal received quality (RSRQ) parameters, along with the UE's location and dropped call information (if calls drop). A relationship between UE distances, from the site's tower, and each of the radio signal parameters is determined, along with the UE distances at the time of a dropped call. Based on which relationship provides the superior prediction of call drop, a handover parameter and possibly a threshold are determined specific to each cell. For example, one cell may use RSRP, an adjacent neighbor cell may use RSRQ, and another adjacent cell may use a weighted combination. This process is updated and may be repeated to continually adjust the handover criteria as cell conditions change (e.g., seasonal and other changes).

Aspects of the disclosure thus improve the performance of cellular (and other wireless) networks by dynamically optimizing handover trigger criteria specific to each cell. This reduces both dropped calls and unnecessarily early handovers, improving both usability and efficiency. These advantageous results are accomplished, at least in part, by using a first relationship (based on at least a first radio signal parameter) and a second relationship, (based on at least a first radio signal parameter): selecting, for a radio site, a handover parameter comprising the first radio signal parameter but not the second radio signal parameter; or selecting, for the radio site, the handover parameter comprising the second radio signal parameter.

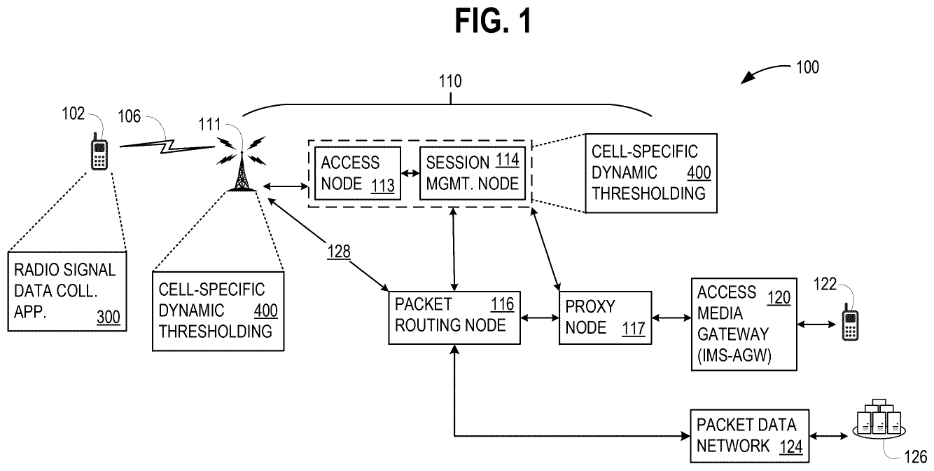

With reference now to the figures, FIG. 1 illustrates an exemplary architecture 100 that advantageously provides cell-specific dynamic thresholding for handover trigger. A wireless network 110 is illustrated that is serving a UE 102. UE 102 may be an enhanced Mobile Broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network. In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

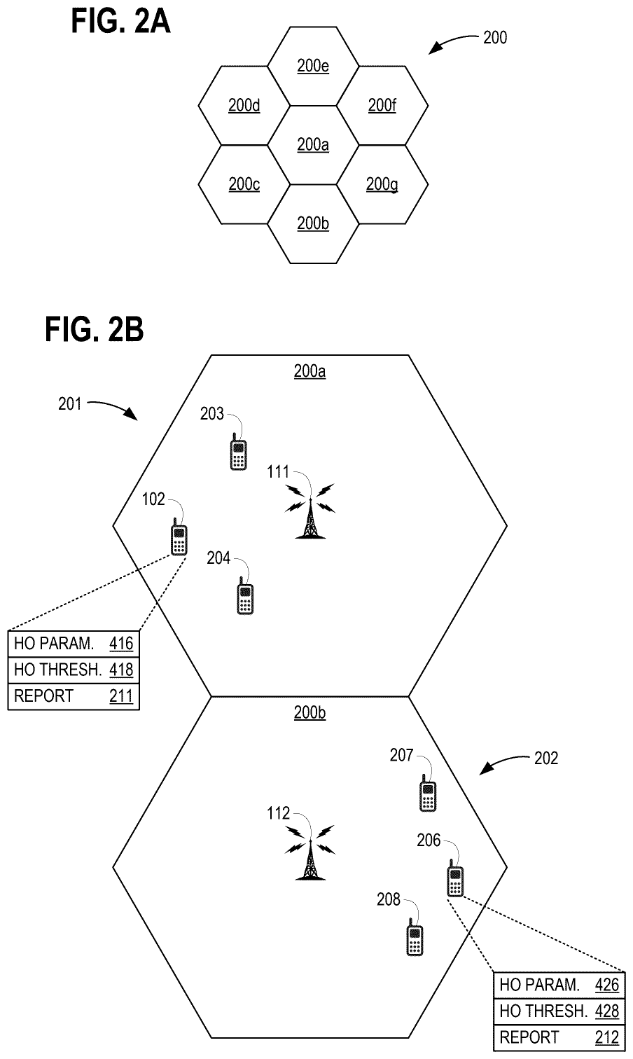

UE 102 uses an air interface 106 to communicate with a base station 111 of wireless network 110, such that base station 111 is the serving base station for UE 102 (providing the serving cell). In some scenarios, base station 111 may be referred to as a radio access network (RAN), and is located at a radio site (See FIG. 2). Wireless network 110 has an access node 113, a session management node 114, and other components (not shown). Wireless network 110 also has a packet routing node 116 and a proxy node 117. Access node 113 and session management node 114 are within a control plane of wireless network 110, and packet routing node 116 is within a data plane (a.k.a. user plane) of wireless network 110.

Base station 111 is in communication with access node 113 and packet routing node 116. Access node 113 is in communication with session management node 114, which is in communication with packet routing node 116 and proxy node 117. Packet routing node 116 is in communication with proxy node 117 and packet data network 124. In some 5G examples, base station 111 comprises a gNodeB (gNB), access node 113 comprises an access mobility function (AMF), session management node 114 comprises a session management function (SMF), and packet routing node 116 comprises a user plane function (UPF).

In some 4G examples, base station 111 comprises an eNodeB (eNB), access node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 117 is in communication with an internet protocol (IP) multimedia system (IMS) access gateway (IMS-AGW) 120 within an IMS, in order to provide connectivity to other wireless (cellular) networks, such as for a call with a UE 122 or a public switched telephone system (PSTN, also known as plain old telephone system, POTS). In some examples, proxy node 117 may be considered to be within the IMS. UE 102 reaches network resource 126 using packet data network 124 (or the IMS, in some examples). Data packets of data traffic 128 to/from UE 102 pass through at least base station 111 and packet routing node 116 on their way from/to packet data network 124 or IMS-AGW 120 (via proxy node 117).

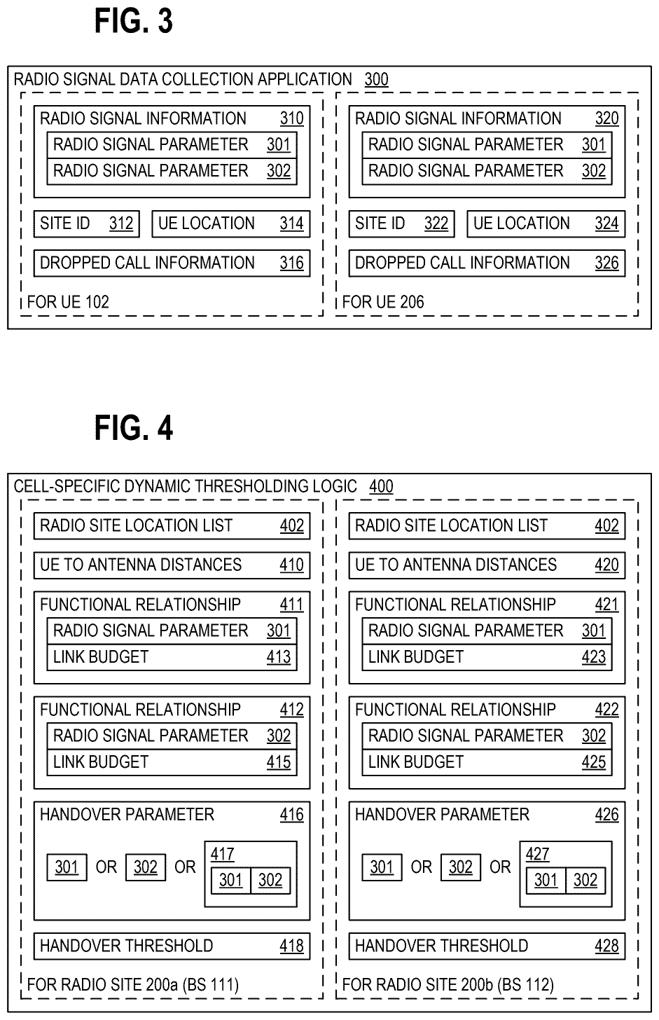

As described more fully below, in relation to the other figures, a radio signal data collection application 300 on UE 102 collects received radio signal information, such as RSRP, RSRQ, and/or other radio signal strength, power, or quality information, along with an identifier (ID) of base station 111, and the location of UE 102. This information is provided to wireless network 110, specifically a cell-specific dynamic thresholding logic 400 that enables independent, cell-specific dynamic thresholding for handover triggers. In some examples, cell-specific dynamic thresholding logic 400 is located within base station 111, or elsewhere within wireless network 110 (e.g., within access node 113), and or distributed among various nodes of wireless network 110. The operations of radio signal data collection application 300 and cell-specific dynamic thresholding logic 400 are described in further detail in relation to FIGS. 3-5.

Although FIG. 1 and some of the following figures are described using an example of a cellular network, it should be understood that the teachings herein are applicable to other types of wireless networks. To benefit from the teachings herein, another type of wireless network should offer geographically-dispersed radio sites with overlapping and/or adjacent coverage, such that a mobile UE being served by one radio site may move to being served by a neighboring radio site as the UE moves further from the first radio site and closer to the second radio site. With such a configuration, the teachings herein may extend to the other types of wireless network.

FIG. 2A illustrates a plurality of radio sites 200 that provides such a configuration, and includes a radio site 200a, a radio site 200b, a radio site 200c, a radio site 200d, a radio site 200e, a radio site 200f, and a radio site 200g. A UE may move around among the various radio sites 200a-200g, and each of radio sites 200a-200g has independent cell-specific dynamic thresholding for handover triggers-specifically optimized for the conditions of that radio site.

FIG. 2B shows radio site 200a with base station 111 serving a plurality of UEs 201 that includes UE 102, a UE 203, and a UE 204. Wireless network 110 has provided UE 102 with a handover parameter 416, which may be RSRP, RSRQ, a weighted combination, or another parameter. Wireless network 110 has also provided UE 102 with a handover threshold 418, and possibly another threshold, such as would be needed for an A5 event report. When the handover criteria is met, UE 102 transmits a UE report 211 (e.g., an A5 report) to base station 111. UEs 203 and 204 are similarly configured. Each UE of plurality of UEs 201 (UE 102, UE 203, and UE 204) has a copy of radio signal data collection application 300 to collect and report on received radio signal information, the ID of base station 111, and its own location.

An adjacent radio site 200b has a base station 112 that is configured similarly to base station 111, but with a different ID (and may operate on a different frequency or cellular generation). Radio site 200b serves a plurality of UEs 202 that includes a UE 206, a UE 207, and a UE 208. Wireless network 110 has provided UE 206 with a handover parameter 426, which may be RSRP, RSRQ, a weighted combination, or another parameter. Wireless network 110 has also provided UE 206 with a handover threshold 428, and possibly another threshold, such as would be needed for an A5 event report. When the handover criteria is met, UE 206 transmits a UE report 212 (e.g., an A5 report) to base station 112. UEs 207 and 208 are similarly configured. Each UE of plurality of UEs 202 (UE 206, UE 207, and UE 208) has a copy of radio signal data collection application 300 to collect and report on received radio signal information, the ID of base station 112, and its own location.

FIG. 3 illustrates further detail for radio signal data collection application 300 that executes on each of the UEs of FIG. 2B. Information is shown for each of UE 102 and UE 206 (each UE has only its own information), and copies of radio signal data collection application 300 for the other UEs 203, 204, 207, and 208 have equivalent information.

For UE 102, received radio signal information 310 includes a radio signal parameter 301 and a radio signal parameter 302. In some examples, radio signal parameter 301 is RSRP and radio signal parameter 302 is RSRQ. In some examples, these are reversed. An ID 312 of radio site 200a identifies base station 111. That is ID 312 identifies both radio site 200a and base station 111. A location 314 of UE 102 is also collected for reporting.

If UE 102 experiences a dropped call, dropped call information 316 is collected and reported by radio signal data collection application 300. Dropped call information 316 may include ID 312 of radio site 200a, location 314 of UE 102, radio signal parameter 301, and radio signal parameter 302 at the time of, or just prior, to the call being dropped. In some scenarios, dropped call information 316 is provided to wireless network 110 when UE 102 regains radio coverage.

For UE 206, received radio signal information 320 also includes radio signal parameter 301 and radio signal parameter 302. An ID 322 of radio site 200b identifies base station 112. That is ID 322 identifies both radio site 200b and base station 112. A location 324 of UE 206 is also collected for reporting. If UE 206 experiences a dropped call, dropped call information 326 is collected and reported by radio signal data collection application 300.

Dropped call information 326 may include ID 322 of radio site 200b, location 324 of UE 206, radio signal parameter 301, and radio signal parameter 302 at the time of, or just prior, to the call being dropped. In some scenarios, dropped call information 326 is provided to wireless network 110 when UE 206 regains radio coverage.

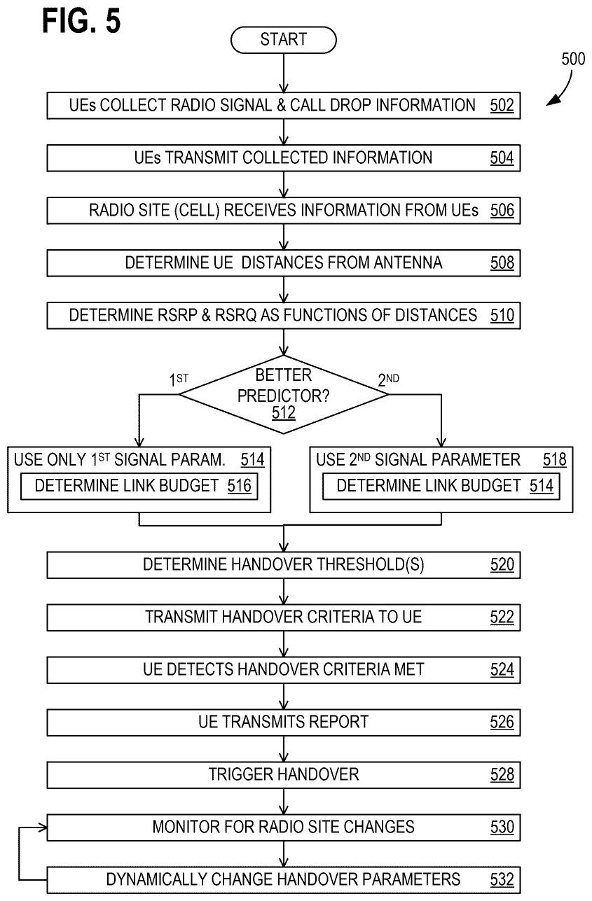

FIG. 4 illustrates further detail for cell-specific dynamic thresholding logic 400. Similarly to FIG. 3, data is shown for two different nodes-in this case, radio site 200a and radio site 200b. For radio site 200a, a radio site location list 402 maps ID 312 (provided by UE 102) to the location of base station 111 (e.g., geographic coordinates). This location information, along with location 314 of UE 102 and locations of other UEs in plurality of UEs 201, enables calculation of UE distances 410 from radio site 200a (i.e., the antenna tower of base station 111) to each UE of plurality of UEs 201.

Using these UE distances 410 and radio signal parameter 301, reported by each UE of plurality of UEs 201, enables determination of a relationship 411 between radio signal parameter 301 and UE distances from radio site 200a. For example, a link budget 413 may be calculated using radio signal parameter 301. Using these UE distances 410 and radio signal parameter 302, also reported by each UE of plurality of UEs 201, enables determination of a relationship 412 between radio signal parameter 302 and UE distances from radio site 200a and. For example, a link budget 415 may be calculated using radio signal parameter 302.

By comparing relationship 411 with relationship 412, and possibly also dropped call information 316, it is possible to ascertain which of radio signal parameter 301 and radio signal parameter 302 provides a superior prediction of dropped calls. For example, if a link budget based on RSRQ is greater than or equal to a link budget based on RSRP, RSRP alone may be the superior parameter to use for triggering a handover. This is typically the case in rural environments, with largely unobstructed views between UEs and the antenna.

In contrast, if a link budget based on RSRQ is less than a link budget based on RSRP, RSRQ alone, or in a weighted combination with RSRP, may be the superior parameter to use for triggering a handover. This is typically the case in urban environments, with significant multi-path propagation.

Handover parameter 416 is selected (determined), using heuristics or possibly artificial intelligence (AI, or machine learning (ML), used synonymously here), which may be radio signal parameter 301 only, radio signal parameter 302 only, or a weighted combination 417 of radio signal parameter 301 and radio signal parameter 302. Handover threshold 418 is also selected (determined) using heuristics or possibly AI. Handover parameter 416 and handover threshold 418 are both provided to all UEs served in radio site 200a (i.e., by base station 111).

For radio site 200b, radio site location list 402 maps ID 322 (provided by UE 206) to the location of base station 112 (e.g., geographic coordinates). This location information, along with location 324 of UE 206 and locations of other UEs in plurality of UEs 202, enables calculation of UE distances 420 from radio site 200b (i.e., the antenna tower of base station 112) to each UE of plurality of UEs 202.

Using these UE distances 420 and radio signal parameter 301, reported by each UE of plurality of UEs 202, enables determination of a relationship 421 between radio signal parameter 301 and UE distances from radio site 200b. For example, a link budget 423 may be calculated using radio signal parameter 301. Using these UE distances 420 and radio signal parameter 302, also reported by each UE of plurality of UEs 202, enables determination of a relationship 422 between radio signal parameter 302 and UE distances from radio site 200b. For example, a link budget 425 may be calculated using radio signal parameter 302. By comparing relationship 421 with relationship 422, and possibly also dropped call information 326, it is possible to ascertain which of radio signal parameter 301 and radio signal parameter 302 provides a superior prediction of dropped calls.

Handover parameter 426 is selected (determined), using heuristics or possibly AI, which may be radio signal parameter 301 only, radio signal parameter 302 only, or a weighted combination 427 of radio signal parameter 301 and radio signal parameter 302. Handover threshold 428 is also selected (determined) using heuristics or possibly AI. Handover parameter 426 and handover threshold 428 are both provided to all UEs served in radio site 200b (i.e., by base station 112).

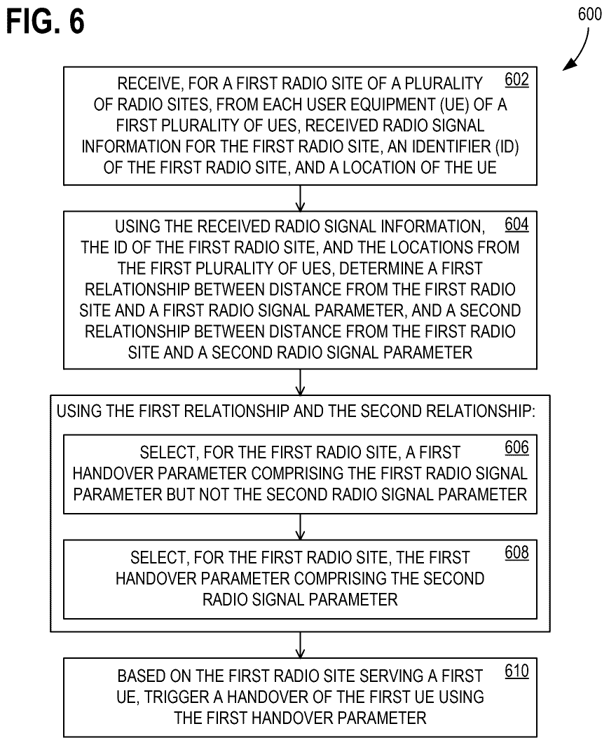

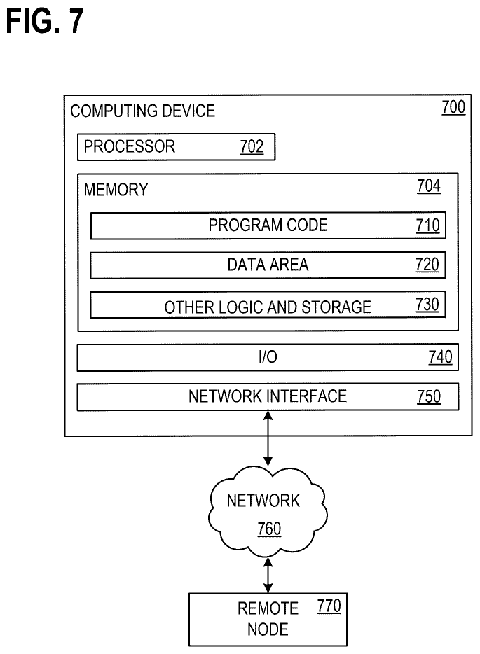

FIG. 5 illustrates a flowchart 500 of exemplary operations associated with architecture 100. In some examples, at least a portion of flowchart 500 may be performed using one or more computing devices 700 of FIG. 7. Flowchart 500 commences with each UE of plurality of UEs 201 collecting received radio signal information 310 for radio site 200a, ID 312 of radio site 200a, and location 314 of the UE, in operation 502. Dropped call information 316 is also collected in operation 502, and all of this collected information is transmitted to base station 111 in operation 504.

In operation 506, wireless network 110 (e.g., base station 111) receives received radio signal information for radio site 200a, ID 312 of radio site 200a, and location 314 of the UEs. In some examples, received radio signal information 320 for radio site 200a comprises radio signal parameter 301 and radio signal parameter 302, each calculated by each UE of plurality of UEs 201. In some examples, radio signal parameter 301 comprises RSRP and radio signal parameter 302 comprises RSRQ; some examples may be reversed from this. In some scenarios, dropped call information 316 is also received.

Operation 508 determines UE distances 410 from radio site 200a to each UE of plurality of UEs 201 using ID 312 of radio site 200a, and locations 314 of the UEs of plurality of UEs 201. Operation 510 uses received radio signal information 310, ID of radio site 200a, and locations 314 from plurality of UEs 201 to determine relationship 411 between radio signal parameter 301 and UE distances 410 from radio site 200a, and also to determine relationship 412 between radio signal parameter 302 and UE distances 410 from radio site 200a. Decision operation 512 determines which of radio signal parameter 301 and radio signal parameter 302 provides the superior handoff criteria (e.g., superior prediction of a call drop) using relationship 411 and relationship 412. If radio signal parameter 301 is preferred, operation 514 selects handover parameter 416 for radio site 200a. Handover parameter 416 comprises radio signal parameter 301 but not radio signal parameter 302. In some examples, selecting handover parameter 416 (and also decision operation 512) comprises determining link budget 413 and/or link budget 415 in operation 516. If radio signal parameter 302 is preferred, operation 518 selects handover parameter 416 for radio site 200a. In this case, however, handover parameter 416 comprises radio signal parameter 302, either alone or in weighted combination 417 with radio signal parameter 301.

Operation 520 determines handover threshold 418 based on at least handover parameter 416 and may also include dropped call information 316. Handover threshold 418 is transmitted to UE 102 and UE 102 is instructed to use handover parameter 416 in operation 522. UE 102 detects that handover conditions are met in operation 524, such as by comparing handover parameter 416 with handover threshold 418, and transmits UE report 211 in operation 526. Based on radio site 200a serving UE 102, wireless network 110 triggers the handover of UE 102 using handover parameter 416 in operation 528.

Operation 530 is ongoing monitoring of relationship 411 and relationship 412 for changes, basically iterating operations 502-512. When there is sufficient change in relationship 411 and/or relationship 412, handover parameter 416 is dynamically changed in operation 532, which is a repeat of operations 514-522.

Flowchart 500 is also performed for other radio sites of plurality of radio sites 200, such as for radio site 200b. Each UE of plurality of UEs 202 collects received radio signal information 320 for radio site 200b, ID 322 of radio site 200b, and location 324 of the UE, in operation 502. Dropped call information 326 is also collected in operation 502, and all of this collected information is transmitted to base station 112 in operation 504.

In operation 506, wireless network 110 (e.g., base station 112) receives received radio signal information for radio site 200b, ID 322 of radio site 200b, and location 324 of the UEs. In some examples, received radio signal information 320 for radio site 200b comprises radio signal parameter 301 and radio signal parameter 302, each calculated by each UE of plurality of UEs 202. In some scenarios, dropped call information 326 is also received.

Operation 508 determines UE distances 420 from radio site 200b to each UE of plurality of UEs 202 using ID 322 of radio site 200b, and UE locations 324 of the UEs of plurality of UEs 202. Operation 510 uses received radio signal information 320, ID of radio site 200b, and UE locations 324 from plurality of UEs 202 to determine relationship 421 between radio signal parameter 301 and UE distances 420 from radio site 200b, and also to determine relationship 422 between radio signal parameter 302 and UE distances 420 from radio site 200b. Decision operation 512 determines which of radio signal parameter 301 and radio signal parameter 302 provides the superior handoff criteria (e.g., superior prediction of a call drop) using relationship 421 and relationship 422. If radio signal parameter 301 is preferred, operation 514 selects handover parameter 426 for radio site 200b. Handover parameter 426 comprises radio signal parameter 301 but not radio signal parameter 302. In some examples, selecting handover parameter 426 (and also decision operation 512) comprises determining link budget 423 and/or link budget 425 in operation 516. If radio signal parameter 302 is preferred, operation 518 selects handover parameter 426 for radio site 200b. In this case, however, handover parameter 426 comprises radio signal parameter 302, either alone or in weighted combination 427 with radio signal parameter 301.

Operation 520 determines handover threshold 428 based on at least handover parameter 426 and may also include dropped call information 326. Handover threshold 428 is transmitted to UE 206 and UE 206 is instructed to use handover parameter 426 in operation 522. UE 206 detects that handover conditions are met in operation 524, such as by comparing handover parameter 426 with handover threshold 428, and transmits UE report 212 in operation 526. Based on radio site 200b serving UE 206, wireless network 110 triggers the handover of UE 206 using handover parameter 426 in operation 528.

Operation 530 is ongoing monitoring of relationship 421 and relationship 422 for changes, basically iterating operations 502-512. When there is sufficient change in relationship 421 and/or relationship 422, handover parameter 426 is dynamically changed in operation 532, which is a repeat of operations 514-522.

FIG. 6 illustrates a flowchart 600 of exemplary operations associated with examples of architecture 100. In some examples, at least a portion of flowchart 600 may be performed using one or more computing devices 700 of FIG. 7. Flowchart 600 commences with operation 602, which includes receiving, for a first radio site of a plurality of radio sites, from each UE of a first plurality of UEs, received radio signal information for the first radio site, an ID of the first radio site, and a location of the UE.

Operation 604 includes using the received radio signal information, ID of the first radio site, and the locations from the first plurality of UEs, determining a first relationship between a first radio signal parameter and UE distances from the first radio site and, and a second relationship between a second radio signal parameter and UE distances from the first radio site and. Operation 606 and 608 are alternatives, and both using the first relationship and the second relationship. Operation 606 includes selecting, for the first radio site, a first handover parameter comprising the first radio signal parameter but not the second radio signal parameter. Operation 608 includes selecting, for the first radio site, the first handover parameter comprising the second radio signal parameter. Operation 610 includes, based on the first radio site serving a first UE, triggering a handover of the first UE using the first handover parameter.

FIG. 7 illustrates a block diagram of computing device 700 that may be used as any component described herein that may require computational or storage capacity. Computing device 700 has at least a processor 702 and a memory 704 that holds program code 710, data area 720, and other logic and storage 730. Memory 704 is any device allowing information, such as computer executable instructions and/or other data, to be stored and retrieved. For example, memory 704 may include one or more random access memory (RAM) modules, flash memory modules, hard disks, solid-state disks, persistent memory devices, and/or optical disks. Program code 710 comprises computer executable instructions and computer executable components including instructions used to perform operations described herein. Data area 720 holds data used to perform operations described herein. Memory 704 also includes other logic and storage 730 that performs or facilitates other functions disclosed herein or otherwise required of computing device 700. An input/output (I/O) component 740 facilitates receiving input from users and other devices and generating displays for users and outputs for other devices. A network interface 750 permits communication over external computer network 760 with a remote node 770, which may represent another implementation of computing device 700. For example, a remote node 770 may represent another of the above-noted nodes within architecture 100.

### Additional Examples

An example system comprises: a processor; and a computer-readable medium storing instructions that are operative upon execution by the processor to: receive, for a first radio site of a plurality of radio sites, from each UE of a first plurality of UEs, received radio signal information for the first radio site, an ID of the first radio site, and a location of the UE; using the received radio signal information, the ID of the first radio site, and the locations from the first plurality of UEs, determine a first relationship between a first radio signal parameter and UE distances from the first radio site, and a second relationship between a second radio signal parameter and UE distances from the first radio site; using the first relationship and the second relationship: select, for the first radio site, a first handover parameter comprising the first radio signal parameter but not the second radio signal parameter; or select, for the first radio site, the first handover parameter comprising the second radio signal parameter; and based on the first radio site serving a first UE, trigger a handover of the first UE using the first handover parameter.

An example method of wireless communication comprises: receiving, for a first radio site of a plurality of radio sites, from each UE of a first plurality of UEs, received radio signal information for the first radio site, an ID of the first radio site, and a location of the UE; using the received radio signal information, ID of the first radio site, and the locations from the first plurality of UEs, determining a first relationship between a first radio signal parameter and UE distances from the first radio site, and a second relationship between a second radio signal parameter and UE distances from the first radio site; using the first relationship and the second relationship: selecting, for the first radio site, a first handover parameter comprising the first radio signal parameter but not the second radio signal parameter; or selecting, for the first radio site, the first handover parameter comprising the second radio signal parameter; and based on the first radio site serving a first UE, triggering a handover of the first UE using the first handover parameter.

One or more example computer storage devices has computer-executable instructions stored thereon, which, upon execution by a computer, cause the computer to perform operations comprising: receiving, for a first radio site of a plurality of radio sites, from each UE of a first plurality of UEs, received radio signal information for the first radio site, an ID of the first radio site, and a location of the UE; using the received radio signal information, ID of the first radio site, and the locations from the first plurality of UEs, determining a first relationship between a first radio signal parameter and UE distances from the first radio site, and a second relationship between a second radio signal parameter and UE distances from the first radio site; using the first relationship and the second relationship: selecting, for the first radio site, a first handover parameter comprising the first radio signal parameter but not the second radio signal parameter; or selecting, for the first radio site, the first handover parameter comprising the second radio signal parameter; and based on the first radio site serving a first UE, triggering a handover of the first UE using the first handover parameter.

Alternatively, or in addition to the other examples described herein, examples include any combination of the following:
each radio site comprises a cellular network cell;
receiving, for a second radio site of the plurality of radio sites, from each UE of a second plurality of UEs, received radio signal information for the second radio site, an ID of the second radio site, and a location of the UE;
using the received radio signal information, ID of the second radio site, and the locations from the second plurality of UEs, determining a third relationship between the first radio signal parameter and UE distances from the second radio site, and a fourth relationship between the second radio signal parameter and UE distances from the second radio site;
using the third relationship and the fourth relationship, selecting, for the second radio site, a second handover parameter comprising the first radio signal parameter but not the second radio signal parameter;
using the third relationship and the fourth relationship, selecting, for the second radio site, the second handover parameter comprising the second radio signal parameter;
based on the second radio site serving a second UE, triggering a handover of the second UE using the second handover parameter;
the second radio site is adjacent to the first radio site;
selection of the second handover parameter is independent of selection of the first handover parameter;
when the first handover parameter comprises the second radio signal parameter, the first handover parameter comprises a weighted combination of the first radio signal parameter and the second radio signal parameter;
when the second handover parameter comprises the second radio signal parameter, the second handover parameter comprises a weighted combination of the first radio signal parameter and the second radio signal parameter;
collecting, by each UE of the first plurality of UEs, the received radio signal information for the first radio site, the ID of the first radio site, and the location of the UE;
collecting, by each UE of the second plurality of UEs, the received radio signal information for the second radio site, the ID of the second radio site, and the location of the UE;
transmitting, to the first base station, the received radio signal information for the first radio site, the ID of the first radio site, and the location of the UE;
transmitting, to the second base station, the received radio signal information for the second radio site, the ID of the second radio site, and the location of the UE;
monitoring the first relationship and the second relationship for changes;
monitoring the third relationship and the fourth relationship for changes;
based on at least a change in the first relationship and/or the second relationship, dynamically changing the first handover parameter;
based on at least a change in the third relationship and/or the fourth relationship, dynamically changing the second handover parameter;
determining a first handover threshold based on at least the first handover parameter;
determining a second handover threshold based on at least the second handover parameter;
transmitting, to the first UE, the first handover threshold;
transmitting, to the second UE, the second handover threshold;
triggering the handover of the first UE using the first handover parameter comprises comparing the first handover parameter with the first handover threshold;
triggering the handover of the second UE using the second handover parameter comprises comparing the second handover parameter with the second handover threshold;
receiving, for the first radio site, dropped call information, the dropped call information comprising a location of a UE upon a dropped call;
receiving, for the second radio site, dropped call information, the dropped call information comprising a location of a UE upon a dropped call;
determining the first handover threshold comprises selecting the first handover parameter using the dropped call information;
determining the second handover threshold comprises selecting the first handover parameter using the dropped call information;
the first radio signal parameter comprises RSRP and the second radio signal parameter comprises RSRQ;
the first radio signal parameter comprises RSRQ and the second radio signal parameter comprises RSRP;
determining the distances from the first radio site to each UE of the first plurality of UEs using the ID of the first radio site, and the locations of the UEs;
determining the distances from the second radio site to each UE of the second plurality of UEs using the ID of the second radio site, and the locations of the UEs;
the received radio signal information for the first radio site comprises the first radio signal parameter and the second radio signal parameter, each calculated by each UE of the first plurality of UEs;
the received radio signal information for the second radio site comprises the first radio signal parameter and the second radio signal parameter, each calculated by each UE of the second plurality of UEs;
selecting the first handover parameter comprises determining a first link budget using the first radio signal parameter and/or a second link budget using the second radio signal parameter; and
selecting the second handover parameter comprises determining a third link budget using the first radio signal parameter and/or a fourth link budget using the second radio signal parameter.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of wireless communication, the method comprising:
receiving, for a first radio site of a plurality of radio sites, from each user equipment (UE) of a first plurality of UEs, received radio signal information for the first radio site, an identifier (ID) of the first radio site, and a location of the UE;
using the received radio signal information, ID of the first radio site, and the locations from the first plurality of UEs, determining a first relationship between a first radio signal parameter and UE distances from the first radio site, and a second relationship between a second radio signal parameter and UE distances from the first radio site;
using the first relationship and the second relationship:
selecting, for the first radio site, a first handover parameter comprising the first radio signal parameter but not the second radio signal parameter; or
selecting, for the first radio site, the first handover parameter comprising the second radio signal parameter; and
based on the first radio site serving a first UE, triggering a handover of the first UE using the first handover parameter.

2. The method of claim 1, further comprising:
receiving, for a second radio site of the plurality of radio sites, from each UE of a second plurality of UEs, received radio signal information for the second radio site, an ID of the second radio site, and a location of the UE;
using the received radio signal information, ID of the second radio site, and the locations from the second plurality of UEs, determining a third relationship between the first radio signal parameter and UE distances from the second radio site, and a fourth relationship between the second radio signal parameter and UE distances from the second radio site;
using the third relationship and the fourth relationship:
selecting, for the second radio site, a second handover parameter comprising the first radio signal parameter but not the second radio signal parameter; or
selecting, for the second radio site, the second handover parameter comprising the second radio signal parameter; and
based on the second radio site serving a second UE, triggering a handover of the second UE using the second handover parameter, wherein the second radio site is adjacent to the first radio site and selection of the second handover parameter is independent of selection of the first handover parameter.

3. The method of claim 1, wherein when the first handover parameter comprises the second radio signal parameter, the first handover parameter comprises a weighted combination of the first radio signal parameter and the second radio signal parameter.

4. The method of claim 1, further comprising:
collecting, by each UE of the first plurality of UEs, the received radio signal information for the first radio site, the ID of the first radio site, and the location of the UE; and
transmitting, to the first radio site, the received radio signal information for the first radio site, the ID of the first radio site, and the location of the UE.

5. The method of claim 1, further comprising:
monitoring the first relationship and the second relationship for changes; and
based on at least a change in the first relationship and/or the second relationship, dynamically changing the first handover parameter.

6. The method of claim 1, further comprising:
determining a first handover threshold based on at least the first handover parameter; and
transmitting, to the first UE, the first handover threshold, wherein triggering the handover of the first UE using the first handover parameter comprises comparing the first handover parameter with the first handover threshold.

7. The method of claim 6, further comprising:
receiving, for the first radio site, dropped call information, the dropped call information comprising a location of a UE upon a dropped call, wherein determining the first handover threshold comprises selecting the first handover parameter using the dropped call information.

8. The method of claim 1,
wherein the first radio signal parameter comprises reference signal received power (RSRP) and the second radio signal parameter comprises reference signal received quality (RSRQ); or
wherein the first radio signal parameter comprises RSRQ and the second radio signal parameter comprises RSRP.

9. A system comprising:
a processor; and
a computer-readable medium storing instructions that are operative upon execution by the processor to:
receive, for a first radio site of a plurality of radio sites, from each user equipment (UE) of a first plurality of UEs, received radio signal information for the first radio site, an identifier (ID) of the first radio site, and a location of the UE;
using the received radio signal information, the ID of the first radio site, and the locations from the first plurality of UEs, determine a first relationship between a first radio signal parameter and UE distances from the first radio site, and a second relationship between a second radio signal parameter and UE distances from the first radio site;
using the first relationship and the second relationship:
select, for the first radio site, a first handover parameter comprising the first radio signal parameter but not the second radio signal parameter; or
select, for the first radio site, the first handover parameter comprising the second radio signal parameter; and
based on the first radio site serving a first UE, trigger a handover of the first UE using the first handover parameter.

10. The system of claim 9, wherein the instructions are further operative to:
receive, for a second radio site of the plurality of radio sites, from each UE of a second plurality of UEs, received radio signal information for the second radio site, an ID of the second radio site, and a location of the UE;
using the received radio signal information, the ID of the second radio site, and the locations from the second plurality of UEs, determine a third relationship between the first radio signal parameter and UE distances from the second radio site, and a fourth relationship between the second radio signal parameter and UE distances from the second radio site;
using the third relationship and the fourth relationship:
select, for the second radio site, a second handover parameter comprising the first radio signal parameter but not the second radio signal parameter; or
select, for the second radio site, the second handover parameter comprising the second radio signal parameter; and
based on the second radio site serving a second UE, triggering a handover of the second UE using the second handover parameter, wherein the second radio site is adjacent to the first radio site and selection of the second handover parameter is independent of selection of the first handover parameter.

11. The system of claim 9, wherein when the first handover parameter comprises the second radio signal parameter, the first handover parameter comprises a weighted combination of the first radio signal parameter and the second radio signal parameter.

12. The system of claim 9, wherein the instructions are further operative to:
monitor the first relationship and the second relationship for changes; and
based on at least a change in the first relationship and/or the second relationship, dynamically change the first handover parameter.

13. The system of claim 9, wherein the instructions are further operative to:
receive, for the first radio site, dropped call information, the dropped call information comprising a location of a UE upon a dropped call;
determining a first handover threshold based on at least the first handover parameter, wherein determining the first handover threshold comprises selecting the first handover parameter using the dropped call information; and
transmitting, to the first UE, the first handover threshold, wherein triggering the handover of the first UE using the first handover parameter comprises comparing the first handover parameter with the first handover threshold.

14. The system of claim 9,
wherein the first radio signal parameter comprises reference signal received power (RSRP) and the second radio signal parameter comprises reference signal received quality (RSRQ); or
wherein the first radio signal parameter comprises RSRQ and the second radio signal parameter comprises RSRP.

15. One or more computer storage devices having computer-executable instructions stored thereon, which, upon execution by a computer, cause the computer to perform operations comprising:
receiving, for a first radio site of a plurality of radio sites, from each user equipment (UE) of a first plurality of UEs, received radio signal information for the first radio site, an identifier (ID) of the first radio site, and a location of the UE;
using the received radio signal information, ID of the first radio site, and the locations from the first plurality of UEs, determining a first relationship between a first radio signal parameter and UE distances from the first radio site, and a second relationship between a second radio signal parameter and UE distances from the first radio site;
using the first relationship and the second relationship:
selecting, for the first radio site, a first handover parameter comprising the first radio signal parameter but not the second radio signal parameter; or
selecting, for the first radio site, the first handover parameter comprising the second radio signal parameter; and
based on the first radio site serving a first UE, triggering a handover of the first UE using the first handover parameter.

16. The one or more computer storage devices of claim 15, wherein the operations further comprise:
receiving, for a second radio site of the plurality of radio sites, from each UE of a second plurality of UEs, received radio signal information for the second radio site, an ID of the second radio site, and a location of the UE;
using the received radio signal information, ID of the second radio site, and the locations from the second plurality of UEs, determining a third relationship between the first radio signal parameter and UE distances from the second radio site, and a fourth relationship between the second radio signal parameter and UE distances from the second radio site;
using the third relationship and the fourth relationship:
selecting, for the second radio site, a second handover parameter comprising the first radio signal parameter but not the second radio signal parameter; or
selecting, for the second radio site, the second handover parameter comprising the second radio signal parameter; and
based on the second radio site serving a second UE, triggering a handover of the second UE using the second handover parameter, wherein the second radio site is adjacent to the first radio site and selection of the second handover parameter is independent of selection of the first handover parameter.

17. The one or more computer storage devices of claim 15, wherein when the first handover parameter comprises the second radio signal parameter, the first handover parameter comprises a weighted combination of the first radio signal parameter and the second radio signal parameter.

18. The one or more computer storage devices of claim 15, wherein the operations further comprise:
monitoring the first relationship and the second relationship for changes; and
based on at least a change in the first relationship and/or the second relationship, dynamically changing the first handover parameter.

19. The one or more computer storage devices of claim 15, wherein the operations further comprise:
receiving, for the first radio site, dropped call information, the dropped call information comprising a location of a UE upon a dropped call,
determining a first handover threshold based on at least the first handover parameter, wherein determining the first handover threshold comprises selecting the first handover parameter using the dropped call information; and
transmitting, to the first UE, the first handover threshold, wherein triggering the handover of the first UE using the first handover parameter comprises comparing the first handover parameter with the first handover threshold.

20. The one or more computer storage devices of claim 15,
wherein the first radio signal parameter comprises reference signal received power (RSRP) and the second radio signal parameter comprises reference signal received quality (RSRQ); or
wherein the first radio signal parameter comprises RSRQ and the second radio signal parameter comprises RSRP.
